(19) United States
(12) Patent Application Publication
(10) Pub. No.: US 2007/0279799 A1
(43) Pub. Date: Dec. 6, 2007

(54) Method of making storage disk drive having reduced space between storage disk and rectifier plate

(75) Inventor: Masaya Suwa, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED

(21) Appl. No.: 11/504,181

(22) Filed: Aug. 15, 2006

(30) Foreign Application Priority Data
May 30, 2006 (JP) 2006-149082

(51) Int. Cl. G11B 5/012

(52) U.S. Cl. 360/97.01

(57) ABSTRACT

A storage disk drive includes storage disks and spacer or spacers stacked in the axial direction of a spindle around a spindle hub. The maximum allowances of axial dimensions of storage disks and a spacer or spacers are cumulated. An accumulated tolerance is calculated for the individual of the storage disks between a reference plane and the upward surface of the individual. A design value of a gap is individually determined between the upward surface of the individual and a rectifier plate opposed to the upward surface of the individual based on the accumulated tolerance for the individual. The space is reduced between the upward surface of the storage disk and the corresponding rectifier plate as compared with the case where the spaces are commonly determined based on the maximum accumulated tolerance. The rectifier plate is allowed to exert the enhanced effect of air bearing on the corresponding storage disk.

### BACKGROUND OF THE INVENTION

1. Field of the Invention

The present invention relates to a storage disk drive or recording disk drive such as a hard disk drive, HDD, for example.

2. Description of the Prior Art

A hard disk drive includes an enclosure containing hard disks or magnetic recording disks. The magnetic recording disks are mounted on a spindle hub. The magnetic recording disks and a spacer or spacers are alternately stacked on the spindle hub.

A rectifier plate is positioned in a space between the adjacent magnetic recording disks. The rectifier plate defines the upper and lower surfaces. The upper surface is opposed to the downward surface of the upper magnetic recording disk. The lower surface is opposed to the upward surface of the lower magnetic recording disk. When the magnetic recording disk is driven to rotate, an air bearing is established between the surface of the rotating magnetic recording disk and the correspondingly opposed rectifier plate. The air bearing serves to suppress flutter of the magnetic recording disk.

In general, the magnetic recording disks are designed to have an identical thickness. The spacers are also designed to have an identical dimension. The unification of the thickness of the magnetic recording disks and the dimension of the spacers is accompanied by unification of the thickness of the rectifier plates. The distance is set equal between each pair of the adjacent rectifier plates. When the magnetic recording disks and the spacers are stacked on the spindle hub, the tolerances of the individual members accumulate. The accumulated tolerance gets larger at an upper position. An identical thickness is set for the rectifier plates in view of the maximum accumulated tolerance and the minimum accumulated tolerance. An identical distance is set for the spaces between the adjacent rectifier plates in view of the maximum accumulated tolerance and the minimum accumulated tolerance. The mentioned unification of the thickness and the spaces greatly contributes to simplification of the process for producing the rectifier plates. A single common tool can be employed in the production. However, the unification causes a distance to get remarkably larger than the accumulated allowance between the rectifier plate and the corresponding magnetic recording disk at a lower position. Flutter cannot sufficiently be suppressed.

### SUMMARY OF THE INVENTION

It is accordingly an object of the present invention to provide a method of making a storage disk drive contributing to a further suppression of flutter for storage disks installed in the storage disk drive. It is an object of the present invention to provide a storage disk drive and an aerodynamic member for the storage disk drive based on the mentioned method.

According to a first aspect of the present invention, there is provided a method of making a storage disk drive, comprising: cumulating maximum allowances of axial dimensions of storage disks and a spacer or spacers so as to calculate an accumulated tolerance for an individual of the storage disks between a reference plane and the upward surface of the individual, the storage disks and spacer or spacers being stacked in the axial direction of a spindle around a spindle hub; and individually determining a design value of a gap between the upward surface of the individual and a rectifier plate opposed to the upward surface of the individual based on the accumulated tolerance for the individual.

The method allows establishment of an optimized value for the design value of the individual gap or space between the upward surface of the storage disk and the corresponding rectifier plate. The space is reduced between the upward surface of the storage disk and the downward surface of the corresponding rectifier plate as compared with the case where the spaces are commonly determined based on the maximum accumulated tolerance. The rectifier plate is allowed to exert the enhanced effect of air bearing on the corresponding storage disk. A further suppression of flutter can be obtained for the rotating storage disks. A larger number of recording tracks can thus be established on the storage disks in a unit area. The storage disk is allowed to enjoy a higher recording density. The method may further comprise determining a design value of a distance between the reference plane and the downward surface of the rectifier plate based on the accumulated tolerance. In this case, the reference plane may be established in the surface of a base supporting the spindle hub.

The method serves to provide a specific storage disk drive at a higher probability. The specific storage disk drive may comprise: a base; a spindle supported on the base; a spindle hub mounted on the spindle; storage disks and a spacer or spacers stacked in the axial direction of the spindle around the spindle hub; and rectifier plates individually opposed to the upward surfaces of the storage disks. A distance is set minimum between a specific one of the rectifier plates and the upward surface of the storage disk, the specific one of the rectifier plates being opposed to the storage disk from the upside at a position closest to the base, the rectifier plate at a position remoter from the base in the axial direction of the spindle being positioned to set a larger distance between the rectifier plate itself and the upward surface of the correspondingly opposed one of the storage disks.

The method may further comprise: cumulating minimum allowances of the axial dimensions so as to calculate a second accumulated tolerance for the individual between the reference plane and the downward surface of the individual; and individually determining a second design value of a gap between the downward surface of the individual and the rectifier plate opposed to the downward surface of the individual based on the second accumulated tolerance for the individual. The method allows establishment of an optimized value for the design value of the individual gap or space between the downward surface of the storage disk and the corresponding rectifier plate. The space is reduced between the downward surface of the storage disk and the upward surface of the corresponding rectifier plate as compared with the case where the spaces are commonly determined based on the minimum accumulated tolerance. The storage disk is allowed to enjoy a higher recording density. Here, the method may further comprise determining a design value of the thickness of the rectifier plate based on the second accumulated tolerance. In this case, the reference plane is established in the surface of a base supporting the spindle hub.

The method allows establishment of a storage disk drive in which a distance is set minimum between a specific one of the rectifier plates and the downward surface of the storage disk, the specific one of the rectifier plates being opposed to the storage disk from the downside at a position closest to the base. Moreover, the rectifier plate at a position remoter from the base in the axial direction of the spindle is positioned to set a larger distance between the rectifier plate itself and the downward surface of the correspondingly opposed one of the storage disks. In general, the rectifier plates are individually positioned in a space between adjacent ones of the storage disks.

An individual one of the rectifier plate preferably shifts toward a lower one of the adjacent storage disks by a predetermined design value in the aforementioned method. The shift enables establishment of a space, between the upper storage disk and the upward surface of the rectifier plate, larger than a space between the lower storage disk and the downward surface of the rectifier plate, in a space between the upper and lower storage disks. In general, the aerodynamic member is lifted by a predetermined lift amount relative to the storage disks when the aerodynamic member is set into the storage disk drive. Accordingly, if the individual rectifier plate is shifted toward the lower storage disk, a contact is reliably prevented between the aerodynamic member and the storage disks when the aerodynamic member is to be set into the storage disk drive. Generation of dust is surely prevented during the setting of the aerodynamic member.

The method may further comprise: calculating the normal distribution of dimension based on the design values and the accumulated tolerance; and calculating the design values based on plus/minus nσ, where n is a numeral, and the amount of production of the storage disk drive. The method enables a further reduction in the space between the upward surface of the storage disk and the downward surface of the rectifier plate. The storage disk drive allows the downward surfaces of the rectifier plates to get closer to the base, respectively, than the corresponding positions set based on the accumulated tolerance derived from the accumulation of the maximum allowances of the storage disks and the spacer or spacers. The rectifier plates are thus allowed to exert a further enhanced effect of air bearing on the corresponding storage disks.

According to a second aspect of the present invention, there is provided a method of making a storage disk drive, comprising: cumulating minimum allowances of axial dimensions of storage disks and a spacer or spacers so as to calculate an accumulated tolerance for an individual of the storage disks between a reference plane and the downward surface of the individual, the storage disks and spacer or spacers being stacked in the axial direction of a spindle around a spindle hub; and individually determining a design value of a gap between the downward surface of the individual and a rectifier plate opposed to the downward surface of the individual based on the accumulated tolerance for the individual.

The method allows establishment of an optimized value for the design value of the individual gap or space between the downward surface of the storage disk and the corresponding rectifier plate. The space is reduced between the downward surface of the storage disk and the upward surface of the corresponding rectifier plate as compared with the case where the spaces are commonly determined based on the minimum accumulated tolerance. The rectifier plate is allowed to exert the enhanced effect of air bearing on the corresponding storage disk. A further suppression of flutter can be obtained for the rotating storage disks. A larger number of recording tracks can thus be established on the storage disks in a unit area. The storage disk is allowed to enjoy a higher recording density. The method may further comprise determining a design value of a distance between the reference plane and the upward surface of the rectifier plate based on the accumulated tolerance. In this case, the reference plane may be established in the surface of a base supporting the spindle hub.

The method may further comprise: calculating the normal distribution of dimension based on the design values and the accumulated tolerance; and calculating the design values based on plus/minus no, where n is a numeral, and the amount of production of the storage disk drive. The method enables a further reduction in the space between the upward surface of the storage disk and the downward surface of the rectifier plate. The storage disk drive allows the downward surfaces of the rectifier plates to get closer to the base, respectively, than the corresponding positions set based on the accumulated tolerance derived from the accumulation of the maximum allowances of the storage disks and the spacer or spacers. The rectifier plates are thus allowed to exert a further enhanced effect of air bearing on the corresponding storage disks.

According to a third aspect of the present invention, there is provided an aerodynamic member for a storage disk drive, comprising: a support piece supported on a base in the storage disk drive, the support piece extending in the axial direction of a spindle; and rectifier plates extending from the support piece in the storage disk drive in the horizontal direction perpendicular to the axial direction, each of the rectifier plates being located in a space between adjacent ones of storage disks mounted on a spindle hub, wherein a distance is set minimum between the adjacent ones of the rectifier plates at a position closest to the base, a distance being set maximum between the adjacent ones of the rectifier plates at a position remotest from the base, the rectifier plate at a position remoter from the base in the axial direction of the spindle being positioned to set a larger distance between the rectifier plate itself and an upward surface of a corresponding one of the rectifier plates. The aerodynamic member of the type greatly contributes to realization of the aforementioned storage disk drive. Otherwise, there may be provided an aerodynamic member for a storage disk drive, comprising: a support piece supported on a base in the storage disk drive, the support piece extending in the axial direction of a spindle; and rectifier plates extending from the support piece in the storage disk drive in the horizontal direction perpendicular to the axial direction, each of the rectifier plates being located in a space between adjacent ones of storage disks mounted on a spindle hub, wherein the thickness is set maximum for one of the rectifier plates at a position closest to the base, the thickness being set minimum for one of the rectifier plates at a position remotest from the base, a smaller thickness being set for the rectifier plate at a position remoter from the base in the axial direction of the spindle. The aerodynamic member of the type likewise greatly contributes to realization of the aforementioned storage disk drive.

### BRIEF DESCRIPTION OF THE DRAWINGS

The above and other objects, features and advantages of the present invention will become apparent from the following description of the preferred embodiment in conjunction with the accompanying drawings, wherein:

FIG. 1 is a plan view schematically illustrating the inner structure of a hard disk drive, HDD, as an example of a storage disk drive according to the present invention;

FIG. 2 is an enlarged partial sectional view taken along the line 2-2 in FIG. 1;

FIG. 3 is an enlarged partial sectional view schematically illustrating the relationship between magnetic recording disks and an aerodynamic member;

FIG. 4 is an enlarged partial sectional view schematically illustrating the dimension of the aerodynamic member;

FIG. 5 is an enlarged partial sectional view schematically illustrating the dimension of the magnetic recording disk;

FIG. 6 is an enlarged partial sectional view schematically illustrating the dimension of a spacer;

FIG. 7 is an enlarged partial sectional view schematically illustrating the accumulated tolerance when the maximum allowances are accumulated in the axial direction;

FIG. 8 is an enlarged partial sectional view schematically illustrating the accumulated tolerance when the minimum allowances are accumulated in the axial direction; and

FIG. 9 is a partial sectional view schematically illustrating the relationship between the magnetic recording disks and the aerodynamic member when the aerodynamic member is to be set into an enclosure base of the hard disk drive.

### DESCRIPTION OF THE PREFERRED EMBODIMENT

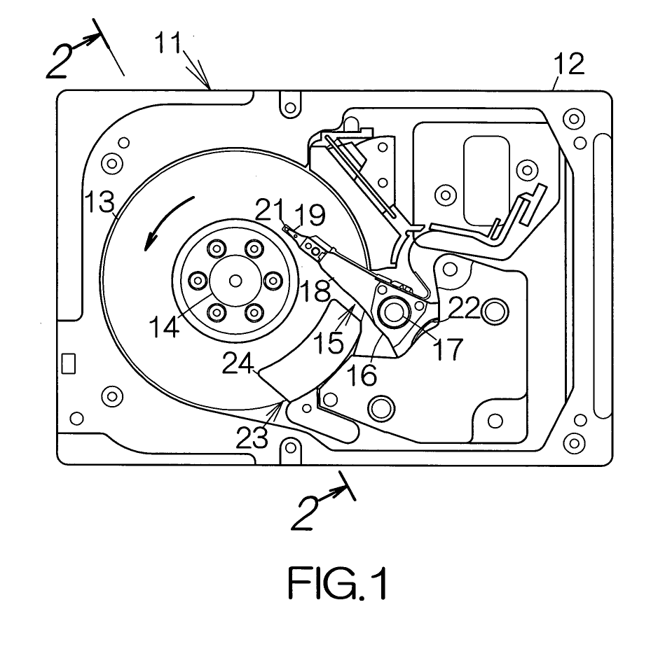

FIG. 1 schematically illustrates the inner structure of a hard disk drive, HDD, 11 as an example of a storage disk drive or recording disk drive according to the present invention. The hard disk drive 11 includes a box-shaped enclosure base 12 defining an inner space of a flat parallelepiped, for example. The enclosure base 12 may be made of a metallic material such as aluminum, for example. Molding process may be employed to form the enclosure base 12. At least one magnetic recording disk 13 as a storage disk is enclosed within the enclosure base 12. The magnetic recording disks 13 are mounted on the driving shaft of a spindle motor 14. The spindle motor 14 drives the magnetic recording disks 13 at a higher revolution speed such as 10,000 rpm, 15,000 rpm, or the like. An enclosure cover, not shown, is coupled to the enclosure base 12. The enclosure cover closes the opening of the enclosure base 12. Pressing process may be employed to form the enclosure cover out of a plate material, for example.

A carriage 15 is also enclosed within the enclosure base 12. The carriage 15 includes a carriage block 16. The carriage block 16 is supported on a vertical support shaft 17 for relative rotation. Rigid carriage arms 18 are defined in the carriage block 16. The carriage arms 18 are designed to extend in a horizontal direction from the vertical support shaft 17. The carriage arms 18 are respectively related to the upper and lower surfaces of the magnetic recording disks 13. The carriage block 16 may be made of aluminum, for example. Molding process may be employed to form the carriage block 16, for example.

A head suspension 19 is attached to the front or tip end of the individual carriage arm 18. The head suspension 19 is designed to extend forward from the carriage arm 18. A flying head slider 21 is supported on the front end of the head suspension 19. The flying head slider 21 is opposed to the surface of the magnetic recording disk 13. As conventionally known, in the case where two or more of the magnetic recording disks 13 are enclosed in the enclosure base 12, a pair of carriage arms 18, namely a pair of head suspensions 19 is located in a space between the adjacent magnetic recording disks 13.

An electromagnetic transducer, not shown, is mounted on the flying head slider 21. The electromagnetic transducer includes a read element and a write element. The read element may include a giant magnetoresistive (GMR) element or a tunnel-junction magnetoresistive (TMR) element designed to discriminate magnetic bit data on the magnetic recording disk 13 by utilizing variation in the electric resistance of a spin valve film or a tunnel-junction film, for example. The write element may include a thin film magnetic head designed to write magnetic bit data into the magnetic recording disk 13 by utilizing a magnetic field induced at a thin film coil pattern.

The head suspension 19 serves to urge the flying head slider 21 toward the surface of the magnetic recording disk 13. When the magnetic recording disk 13 rotates, an airflow is generated along the rotating magnetic recording disk 13. The airflow serves to generate a positive pressure or a lift on the flying head slider 21. The flying head slider 21 is thus allowed to keep flying above the surface of the magnetic recording disk 13 during the rotation of the magnetic recording disk 13 at a higher stability established by the balance between the urging force of the head suspension 19 and the lift.

A power source or voice coil motor, VCM, 22 is coupled to the carriage block 16. The voice coil motor 22 serves to drive the carriage block 16 around the vertical support shaft 17. The rotation of the carriage block 16 allows the carriage arms 18 and the head suspensions 19 to swing. When the carriage arm 18 swings around the vertical support shaft 17 during the flight of the flying head slider 21, the flying head slider 21 is allowed to move along the radial direction of the magnetic recording disk 13. The electromagnetic transducer on the flying head slider 21 can thus be positioned right above a target recording track on the magnetic recording disk 13.

An aerodynamic member 23 is fixed to the bottom plate of the enclosure base 12 at a position outside the magnetic recording disks 13. The aerodynamic member 23 includes rectifier plates 24 opposed to the upper and lower surfaces of the magnetic recording disks 13. When the magnetic recording disks 13 rotate, an airflow is generated to flow along the upper and lower surfaces of the magnetic recording disks 13. The airflow serves to establish an air bearing between the rectifier plate 24 and the magnetic recording disk 13. The air bearing serves to suppress flutter or vibration of the rotating magnetic recording disk 13. A detailed description will be made on the aerodynamic member 23.

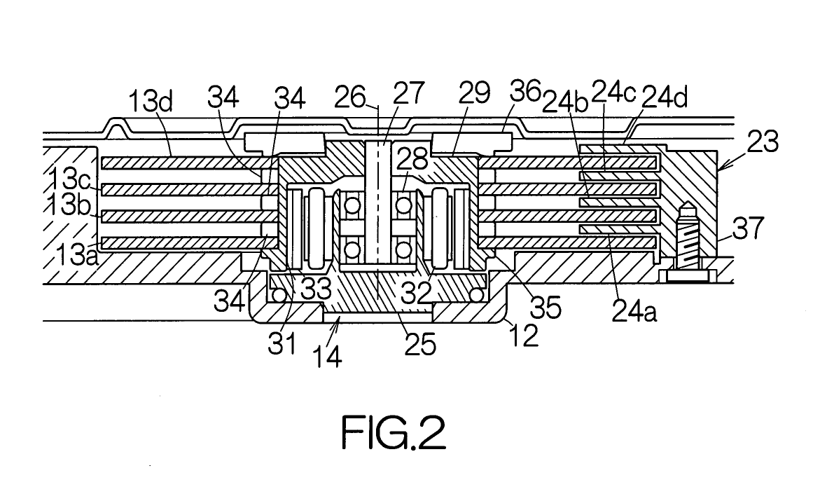

As shown in FIG. 2, the spindle motor 14 includes a base member 25 fixed to the bottom plate of the enclosure base 12. A spindle 27 is supported on the base 25 for relative rotation around a vertical axis 26. Bearing such a set of ball bearings 28 may be employed to support the spindle 27, for example. Alternatively, a fluid bearing may be employed in place of the ball bearings 28.

A spindle hub 29 is mounted on the spindle 27. A hollow space 31 is defined inside the spindle hub 29 around the spindle 27. Electromagnetic coils 32 and permanent magnets 33 are arranged in the hollow space 31. The electromagnet coils 32 are fixed to the base member 25 around the spindle 27. The permanent magnets 33 are fixed to the spindle hub 29 around the electromagnetic coils 32. When electric power is supplied to the electromagnetic coils 32, the electromagnetic coils 32 generate a magnetic field repulsive to the magnetic field from the permanent magnets 33 so that the spindle hub 29 is driven to rotate around the rotation axis of the spindle 27. The rotation axis of the spindle 27 coincides with the vertical axis 26.

The magnetic recording disks 13 (13a-13d) and spacers 34 are sequentially mounted on the spindle hub 29. The spacer 34 is held between the adjacent magnetic recording disks 13a-13d. A flange 35 is formed at the lower end of the spindle hub 29 so as to extend in the centrifugal direction. The flange 35 serves to receive the lowest magnetic recording disk 13a. The magnetic recording disks 13a-13d and the spacers 34 are in this manner alternately stacked in the axial direction of the spindle 27 around the spindle hub 29. The individual magnetic recording disk 13 extends in the horizontal direction perpendicular to the vertical axis 26.

A clamp 36 is fixed to the upper end of the spindle hub 29. The clamp 36 contacts the uppermost magnetic recording disk 13d. The clamp 36 is designed to urge the magnetic recording disks 13a-13d and the spacers 34 against the flange 35. The magnetic recording disks 13a-13d are in this manner steadily mounted on the spindle hub 29.

Here, the aerodynamic member 23 includes a support piece 37 standing upright from the bottom plate of the enclosure base 12. The support piece 37 extends in parallel with the axial direction of the spindle 27. The support piece 37 is opposed to the outer peripheral ends of the magnetic recording disks 13a-13d. Rectifier plates 24a-24d are attached to the support piece 37. Molding process may be employed to form the support piece 37 and the rectifier plates 24a-24d in a single-piece component made of a resin material, for example. The individual rectifier plate 24a, 24b, 24c is arranged in a space between the adjacent magnetic recording disks 13a, 13b, 13c, 13d. The upward surface of the individual rectifier plate 24a, 24b, 24c is opposed to the downward surface of the corresponding magnetic recording disk 13b, 13c, 13d from the downside. The downward surface of the individual rectifier plate 24a, 24b, 24c is opposed to the upward surface of the corresponding magnetic recording disk 13a, 13b, 13c from the upside. The rectifier plate 24d is opposed to the upward surface of the uppermost magnetic recording disk 13d. Here, four of the rectifier plates 24a-24d are related to four of the magnetic recording disks 13a-13d.

As is apparent from FIG. 3, the hard disk drive 11 allows establishment of the minimum space x₁ between the upward surface of the magnetic recording disk 13a and the rectifier plate 24a opposed to the upward surface of the magnetic recording disk 13a from the upside at a location closest to the bottom plate of the enclosure base 12. A space x₂ larger than the minimum space x₁ is established between the upward surface of the magnetic recording disk 13b and the rectifier plate 24b opposed to the upward surface of the magnetic recording disk 13b from the upside. A space x₃ larger than the space x₂ is also established between the upward surface of the magnetic recording disk 13c and the rectifier plate 24c opposed to the upward surface of the magnetic recording disk 13c from the upside. A space x₄ larger than the space x₃ is established between the upward surface of the magnetic recording disk 13d and the rectifier plate 24d opposed to the upward surface of the magnetic recording disk 13d from the upside. The downward surface of the rectifier plate 24a, 24b, 24c, 24d at a position remoter from the bottom plate of the enclosure base 12 in the axial direction of the spindle 27 allows establishment of a larger space between the downward surface of the rectifier plate 24a, 24b, 24c, 24d and the upward surface of the corresponding magnetic recording disk 13a, 13b, 13c, 13d.

The hard disk drive 11 likewise allows establishment of the minimum space y₁ between the downward surface of the magnetic recording disk 13b and the rectifier plate 24a opposed to the downward surface of the magnetic recording disk 13b from the downside at a location closest to the bottom plate of the enclosure base 12. A space y₂ larger than the minimum space y₁ is established between the downward surface of the magnetic recording disk 13c and the rectifier plate 24b opposed to the downward surface of the magnetic recording disk 13c from the downside. A space y₃ larger than the space y₂ is also established between the downward surface of the magnetic recording disk 13d and the rectifier plate 24c opposed to the downward surface of the magnetic recording disk 13d from the downside. The upward surface of the rectifier plate 24a, 24b, 24c at a position remoter from the bottom plate of the enclosure base 12 in the axial direction of the spindle 27 allows establishment of a larger space between the upward surface of the rectifier plate 24a, 24b, 24c and the downward surface of the corresponding magnetic recording disk 13b, 13c, 13d.

Moreover, the hard disk drive 11 allows establishment of the space y₁, y₂, y₃, larger than the space x₁, x₂, x₃ between the downward surface of the rectifier plate 24a, 24b, 24c and the upward surface of the corresponding magnetic recording disk 13a, 13b, 13c, between the upward surface of the rectifier plate 24a, 24b, 24c and the downward surface of the corresponding magnetic recording disk 13b, 13c, 23d in a space between the respective adjacent magnetic recording disks 13a-13d. Here, a uniform value z is set for the difference (y₁−x₁), (y₂−x₂) and (y₃−x₃) between the individual space x₁, x₂, x₃ and the corresponding space y₁, y₂, y₃.

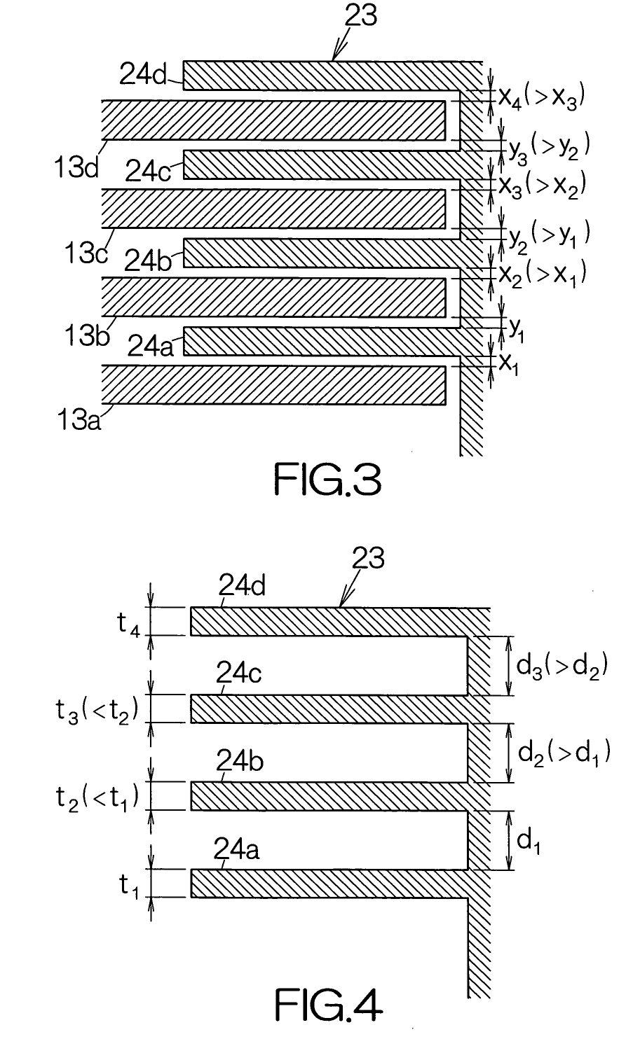

In this case, the aerodynamic member 23 allows establishment of the minimum space d₁ between the adjacent rectifier plates 24a, 24b at a position closest to the bottom plate of the enclosure base 12, as shown in FIG. 4, since a common magnetic recording disk is employed as the individual magnetic recording disks 13a-13d. To the contrary, the maximum space d₃ is established between the adjacent rectifier plates 24c, 24d at a position remotest from the bottom plate of the enclosure base 12. The rectifier plates 24a-24d are designed to set a larger space d₁, d₂, d₃ between the adjacent rectifier plates 24a-24d at a position remoter from the bottom plate of the enclosure base 12 in the axial direction of the spindle 27. In addition, since a common spacer is utilized for the individual spacer 34, the aerodynamic member 23 allows establishment of the largest thickness t₁ for the rectifier plate 24a closest to the bottom plate of the enclosure base 12. The aerodynamic member 23 also allows establishment of the smallest thickness t₃ for the rectifier plate 24c remotest from the bottom plate of the enclosure base 12. Specifically, the rectifier plates 24a-24c are designed to have a smaller thickness t₁, t₂, t₃ at a position remoter from the bottom plate of the enclosure base 12 in the axial direction of the spindle 27. Here, the rectifier plate 24d may have any thickness t4 since the rectifier plate 24d is located outside the space between the adjacent magnetic recording disks 13.

Next, a detailed description will be made on a method of making the hard disk drive 11. As shown in FIG. 5, the magnetic recording disk 13a-13d has an axial dimension or thickness a [mm]. A dimensional tolerance is set at plus/minus α [μm]. As shown in FIG. 6, the spacer 34 has an axial dimension or thickness b [mm]. A dimensional tolerance and an error in parallelism of the spacer 34 induce a displacement of the outer rim of the magnetic recording disk 13b-13d in the axial direction. The displacement of the magnetic recording disk 13b-13d can be identified as plus/minus β [μm]. Now, when the upper end of the flange 35 defines a reference plane, the height (a±α) is identified for the upward surface of the lowest magnetic recording disk 13a above the reference plane. The height (a±α+b±β) is identified for the downward surface of the magnetic recording disk 13b above the reference plane. The height (2a±2α+b±β) is identified for the upward surface of the magnetic recording disk 13b above the reference plane. The height (2a±2α+2b±2β) is identified for the downward surface of the magnetic recording disk 13c above the reference plane. The height (3a±3α+2b±2β) is identified for the upward surface of the magnetic recording disk 13c above the reference plane. The height (3a±3α+3b±3β) is identified for the downward surface of the magnetic recording disk 13d above the reference plane. The height (4a±4α+3b±3β) is identified for the upward surface of the magnetic recording disk 13d above the reference plane.

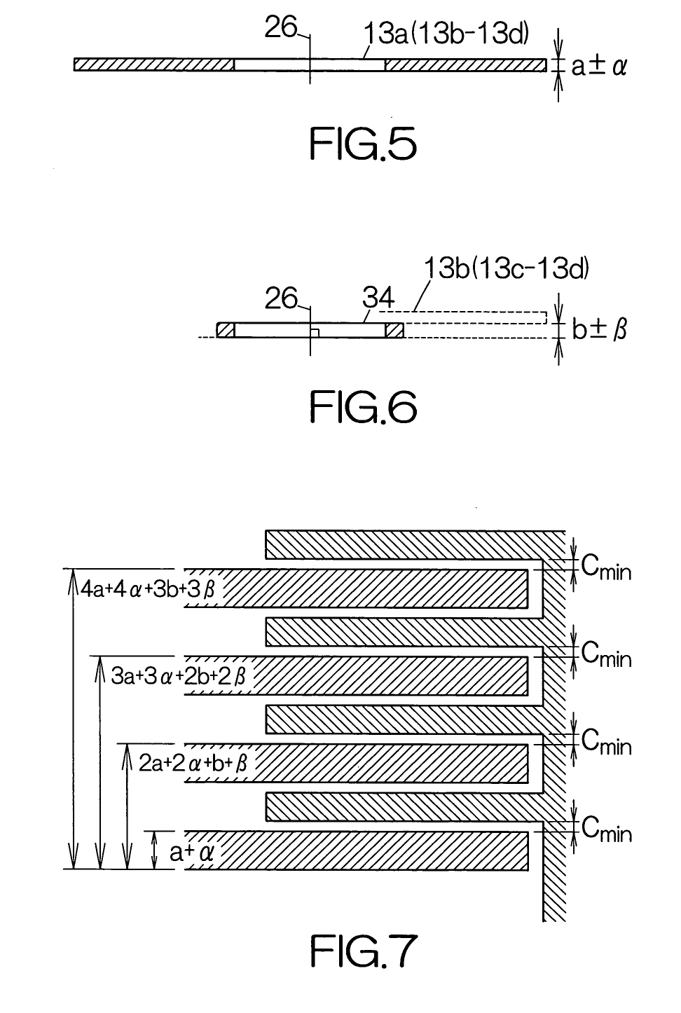

In this case, when the maximum allowances of the axial dimensions for the magnetic recording disks 13a-13d and the spacers 34 are accumulated, the upward surface of the magnetic recording disk 13a can be located at the height of (a+α) above the reference plane, as shown in FIG. 7. The upward surface of the magnetic recording disk 13b can be located at the height of (2a+2α+b+β). The upward surface of the magnetic recording disk 13c can be located at the height of (3a+3α+2b+2β). The upward surface of the magnetic recording disk 13d can be located at the height of (4a+4α+3b+3β). The upward surface of the magnetic recording disk 13a, 13b, 13d, 13d is located farthest from the reference plane. The accumulated tolerance +α is identified relative to the designed position for the magnetic recording disk 13a. The accumulated tolerance (+2α+β) is identified relative to the designed position for the magnetic recording disk 13b. The accumulated tolerance (+3α+2β) is identified relative to the designed position for the magnetic recording disk 13c. The accumulated tolerance (+4α+3β) is identified relative to the designed position for the magnetic recording disk 13d.

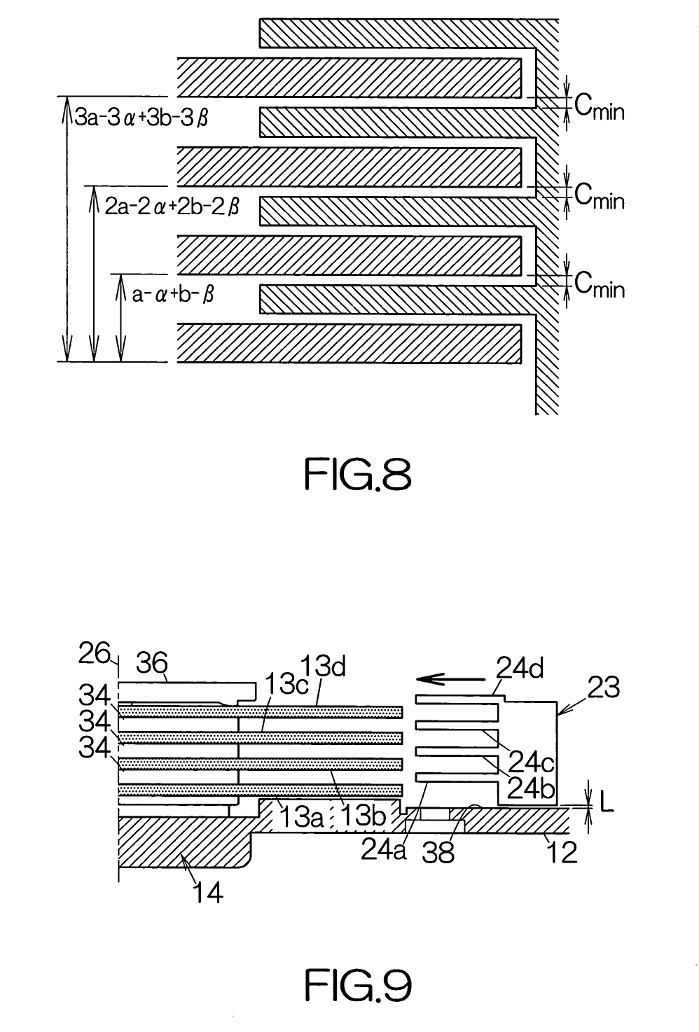

To the contrary, when the minimum allowances of the axial dimensions for the magnetic recording disks 13a-13d and the spacers 34 are accumulated, the downward surface of the magnetic recording disk 13b can be located at the height of (a−α+b−β) above the reference plane, as shown in FIG. 8. The downward surface of the magnetic recording disk 13c can be located at the height of (2a−2α+2b−2β) above the reference plane. The downward surface of the magnetic recording disk 13d can be located at the height of (3a−3α+3b−3β) above the reference plane. The upward surface of the magnetic recording disk 13b, 13c, 13d is located closest to the reference plane. The accumulated tolerance (−α−β) is identified relative to the designed position for the magnetic recording disk 13b. The accumulated tolerance (−2α−2β) is identified relative to the designed position for the magnetic recording disk 13c. The accumulated tolerance (−3α−3β) is identified relative to the designed position for the magnetic recording disk 13d.

The aforementioned accumulated tolerance is taken into account in designing the aerodynamic member 23. Specifically, the extent of the space is determined between the adjacent rectifier plates 24a-24d. The thickness is determined for the rectifier plates 24a-24d. A common minimum clearance Cₘᵢₙ is first set between the individual magnetic recording disk 13a-13d and the corresponding rectifier plate 24a-24d. The common minimum clearance Cₘᵢₙ corresponds to a space sufficiently avoiding a contact between the individual magnetic recording disk 13a-13d and the rectifier plates 24a-24d in the hard disk drive 11 during the operation of the hard disk drive 11. Various factors, such as a displacement of the magnetic recording disks 13a-13d and the rectifier plates 24a-24d at the application of an impact, a tolerance in assembling process, or the like, may be taken into account in determining the minimum clearance Cₘᵢₙ. The smaller minimum clearance Cₘᵢₙ serves to improve the effect of the rectifier plates 24a-24d. Flutter is suppressed in the rotating magnetic recording disks 13a-13d.

The individual accumulated tolerance is added to the minimum clearance Cₘᵢₙ. Specifically, the tolerance α is added to the minimum clearance Cₘᵢₙ for the space between the upward surface of the magnetic recording disk 13a and the downward surface of the rectifier plate 24a. The accumulated tolerance (α+β) is likewise added to the minimum clearance Cₘᵢₙ for the space between the downward surface of the magnetic recording disk 13b and the upward surface of the rectifier plate 24a. The accumulated tolerance (2α+β) is added to the minimum clearance Cₘᵢₙ for the space between the upward surface of the magnetic recording disk 13b and the downward surface of the rectifier plate 24b. The accumulated tolerance (2α+2β) is added to the minimum clearance Cₘᵢₙ for the space between the downward surface of the magnetic recording disk 13c and the upward surface of the rectifier plate 24b. The accumulated tolerance (3α+2β) is added to the minimum clearance Cₘᵢₙ for the space between the upward surface of the magnetic recording disk 13c and the downward surface of the rectifier plate 24c. The accumulated tolerance (3α+3β) is added to the minimum clearance Cₘᵢₙ for the space between the downward surface of the magnetic recording disk 13d and the upward surface of the rectifier plate 24c. The accumulated tolerance (4α+3β) is added to the minimum clearance Cₘᵢₙ for the space between the upward surface of the magnetic recording disk 13d and the downward surface of the rectifier plate 24d. In this manner, the design value of the space x₁, x₂, x₃, x₄ is individually set between the upward surface of the individual magnetic recording disk 13a, 13b, 13c, 13d and the corresponding rectifier plate 24a, 24b, 24c, 24d based on the accumulated tolerance of the maximum allowances. The design value of the space y₁, y₂, y₃ is likewise individually set between the downward surface of the individual magnetic recording disk 13b, 13c, 13d and the rectifier plate 24a, 24b, 24c based on the accumulated tolerance of the minimum allowances. Here, a predetermined design value, namely a lift clearance z is added to the design value for the space y₁, y₂, y₃ between the downward surface of the magnetic recording disk 13b, 13c, 13d and the corresponding rectifier plate 24a, 24b, 24c. The lift clearance z will described later in detail.

When the spaces x₁, x₂, x₃, x₄, y₁, y₂, y₃ are in this manner determined between the upward surface and the rectifier plate 24a, 24b, 24c, 24d and between the downward surface and the rectifier plate 24b, 24c, 24d for the individual magnetic recording disk 13a, 13b, 13c, 13d, the height can be identified for the upward and downward surfaces of the individual rectifier plate 24a-24d, in other words, the upward and downward surfaces of the rectifier plates 24a-24d can be located. This enables determination of the space or distance between the adjacent rectifier plates 24a-24d and the thickness of the individual rectifier plate 24a-24d. The design values are in this manner obtained for the individual space between the adjacent rectifier plates 24a-24d and the thickness of the individual rectifier plate 24a-24d. The design values reflect the consideration on the dimensional tolerance of the aerodynamic member 23.

The aforementioned method enables a reliable avoidance of a contact between the individual magnetic recording disk 13a-13d and the corresponding rectifier plate 24a-24d even if the accumulated tolerance is established based on the accumulation of only the maximum allowances of the magnetic recording disks 13a-13d and the spacers 34. In addition, the aforementioned method enables a reliable avoidance of a contact between the individual magnetic recording disk 13b-13d and the corresponding rectifier plate 24a-24c even if the accumulated tolerance is established based on the accumulation of only the minimum allowances of the magnetic recording disks 13a-13d and the spacers 34. Moreover, the space is reliably minimized between the individual magnetic recording disk 13a-13d and the corresponding rectifier plate or plates 24a-24d. The rectifier plates 24a-24d are allowed to exert the maximum effect of the air bearing on the magnetic recording disks 13a-13d. The inventor has demonstrated that the magnetic recording disks 13a-13d are allowed to enjoy a 5% reduction of the non-repeatable runout (NRRO) if the space is minimized between the individual magnetic recording disk 13a-13d and the corresponding rectifier plates 24a-24d in the aforementioned manner.

Now, assume that the aforementioned aerodynamic member 23 is set into the enclosure base 12 of the hard disk drive 11. As shown in FIG. 9, a flat surface 38 is established on the bottom plate of the enclosure base 12 in parallel with the aforementioned reference plane, for example. The aerodynamic member 23 is placed on the flat surface 38. The spindle motor 14 is previously set on the enclosure base 12 prior to the set of the aerodynamic member 23. The magnetic recording disks 13a-13d and the spacers 34 have been mounted on the spindle motor 14.

The aerodynamic member 23 is moved in parallel with the reference plane. The aerodynamic member 23 is lifted by a predetermined lift amount L above the flat surface 38. A robot is utilized to lift the aerodynamic member 23, for example. The lift amount L coincides with the aforementioned lift clearance z. A contact is avoided between the support piece 37 of aerodynamic member 23 and the enclosure base 12 during the movement of the aerodynamic member 23 in parallel with the flat surface 38. Generation of dust is thus prevented during the setting of the aerodynamic member 23. The lift amount L is set at 70 [μm] approximately, for example.

In addition, the lift clearance z is included in the space between the upward surfaces of the rectifier plates 24a-24c and the downward surfaces of the corresponding magnetic recording disks 13b-13d in the aforementioned manner. Accordingly, a contact is reliably prevented between the upward surfaces of the rectifier plates 24a-24c and the downward surfaces of the corresponding magnetic recording disks 13b-13d during the movement of the aerodynamic member 23 in parallel with the flat surface 38, even if the accumulated tolerance is established based on the accumulation of only the minimum allowances of the magnetic recording disks 13a-13d and the spacers 34. Accordingly, the magnetic recording disks 13a-13d are reliably prevented from suffering from generation of scratches on the surface and generation of dust during the setting of the aerodynamic member 23 into the enclosure base 12. It should be noted that the inclination of the robot, the accuracy of positioning the robot, the parallelism of the aerodynamic member 23 held on the robot, and the like, may be taken into account in determining the lift clearance z.

The hard disk drive 11 may allow the downward surfaces of the rectifier plates 24a-24d to get closer to the corresponding magnetic recording disks 13a-13d, respectively. Specifically, a predetermined value smaller than the maximum allowance α, (2α+β), (3α+2β) and (4α+3β) may be added to the minimum clearance Cₘᵢₙ for the aforementioned space x₁, x₂, x₃, x₄. In this case, the probability of a contact between the magnetic recording disks 13a-13d and the rectifier plates 24a-24d may be taken into account to realize a closer arrangement of the rectifier plates 24a-24d toward the corresponding magnetic recording disks 13a-13d. Here, 3σ may be set for the accumulated tolerance, for example. The 3σ corresponds to the value “1” for the process capability index. The sum of squares Σ(α₂+β₂) is calculated for the accumulated tolerance α, β. The square root of the sum of squares is set at 3σ. The distribution or dispersion of the accumulated tolerance is estimated based on the normal distribution for the individual magnetic recording disk 13a, 13b, 13c, 13d. The normal distribution allows 68.26% of the entirety to fall into the range of ±1σ. 95.44% of the entirety falls into the range of ±2σ. 99.73% of the entirety falls into the range of ±3σ. 99.9937% of the entirety falls into the range of ±4σ.

Now, assume that 2σ is set for the spaces between the magnetic recording disks 13a-13d and the corresponding rectifier plates 24a-24d, for example. The magnetic recording disks 13a-13d and the corresponding rectifier plates 24a-24d suffer from a contact therebetween at the probability of 4.56% based on the aforementioned tolerances α, β. Accordingly, if ten of the hard disk drives 11 are produced, for example, a contact is surely avoided between the magnetic recording disks 13a-13d and the corresponding rectifier plates 24a-24d in any of the hard disk drives 11. In addition, the space between the individual magnetic recording disk 13a-13d and the corresponding rectifier plate 24a-24d is set at a value smaller than the aforementioned value including the tolerances α, β. Flutter is thus further suppressed in the rotating magnetic recording disks 13a-13d in the hard disk drives 11. If 3σ is set for the spaces between the magnetic recording disks 13a-13d and the corresponding rectifier plates 24a-24d, for example, the magnetic recording disks 13a-13d and the corresponding rectifier plates 24a-24d suffer from a contact therebetween at the probability of 0.27% based on the aforementioned tolerances α, β. Accordingly, if a hundred of the hard disk drives 11 are produced, for example, a contact is surely avoided between the magnetic recording disks 13a-13d and the corresponding rectifier plates 24a-24d in any of the hard disk drives 11. In addition, the space between the individual magnetic recording disk 13a-13d and the corresponding rectifier plate 24a-24d is set at a value remarkably smaller than the aforementioned value including the tolerances α, β. If 4σ is set for the spaces between the magnetic recording disks 13a-13d and the corresponding rectifier plates 24a-24d, for example, the magnetic recording disks 13a-13d and the corresponding rectifier plates 24a-24d suffer from a contact therebetween at the probability of 0.0063% based on the aforementioned tolerances α, β. Accordingly, if the mass production of the hard disk drives 11 is realized, for example, only a hard disk drive 11 among 16,000 of the hard disk drives 11 suffers from a contact between the magnetic recording disks 13a-13d and the corresponding rectifier plates 24a-24d. A higher yield can be obtained. In addition, the space between the individual magnetic recording disk 13a-13d and the corresponding rectifier plate 24a-24d is set at a value smaller than the aforementioned value including the tolerances α, β. The inventor has demonstrated that the magnetic recording disks 13a-13d are allowed to enjoy a 10% reduction of the non-repeatable runout if the space x₁, x₂, x₃, x₄ is optimized based on 3σ between the upward surface of the individual magnetic recording disk 13a-13d and the downward surface of the corresponding rectifier plates 24a-24d in the aforementioned manner.

What is claimed is:

1. A method of making a storage disk drive, comprising:
cumulating maximum allowances of axial dimensions of storage disks and a spacer or spacers so as to calculate an accumulated tolerance for an individual of the storage disks between a reference plane and an upward surface of the individual, said storage disks and spacer or spacers being stacked in an axial direction of a spindle around a spindle hub; and
individually determining a design value of a gap between the upward surface of the individual and a rectifier plate opposed to the upward surface of the individual based on the accumulated tolerance for the individual.

2. The method according to claim 1, further comprising determining a design value of a distance between the reference plane and a downward surface of the rectifier plate based on the accumulated tolerance, wherein
the reference plane is established in a surface of a base supporting the spindle hub.

3. The method according to claim 1, further comprising:
cumulating minimum allowances of the axial dimensions so as to calculate a second accumulated tolerance for the individual between the reference plane and a downward surface of the individual; and
individually determining a second design value of a gap between the downward surface of the individual and the rectifier plate opposed to the downward surface of the individual based on the second accumulated tolerance for the individual.

4. The method according to claim 1, further comprising determining a design value of thickness of the rectifier plate based on the second accumulated tolerance, wherein
the reference plane is established in a surface of a base supporting the spindle hub.

5. The method according to claim 4, wherein an individual one of the rectifier plate shifts toward a lower one of the adjacent storage disks by a predetermined design value.

6. The method according to claim 1, further comprising:
calculating a normal distribution of dimension based on the design values and the accumulated tolerance; and
calculating the design values based on plus/minus nσ, where n is a numeral, and an amount of production of the storage disk drive.

7. The method according to claim 3, further comprising:
calculating a normal distribution of dimension based on the second design values and the second accumulated tolerance; and
calculating the second design values based on plus/minus nσ, where n is a numeral, and an amount of production of the storage disk drive.

8. A method of making a storage disk drive, comprising:
cumulating minimum allowances of axial dimensions of storage disks and a spacer or spacers so as to calculate an accumulated tolerance for an individual of the storage disks between a reference plane and a downward surface of the individual, said storage disks and spacer or spacers being stacked in an axial direction of a spindle around a spindle hub; and
individually determining a design value of a gap between the downward surface of the individual and a rectifier plate opposed to the downward surface of the individual based on the accumulated tolerance for the individual.

9. The method according to claim 8, further comprising determining a design value of a distance between the reference plane and an upward surface of the rectifier plate based on the accumulated tolerance, wherein
the reference plane is established in a surface of a base supporting the spindle hub.

10. The method according to claim 8, further comprising:
calculating a normal distribution of dimension based on the design values and the accumulated tolerance; and
calculating the design values based on plus/minus nσ, where n is a numeral, and an amount of production of the storage disk drive.

11. A storage disk drive comprising:
a base;
a spindle supported on the base;
a spindle hub mounted on the spindle;
storage disks and a spacer or spacers stacked in an axial direction of the spindle around the spindle hub; and
rectifier plates individually opposed to upward surfaces of the storage disks, wherein
a distance is set minimum between a specific one of the rectifier plates and the upward surface of the storage disk, said specific one of the rectifier plates being opposed to the storage disk from an upside at a position closest to the base, the rectifier plate at a position remoter from the base in the axial direction of the spindle being positioned to set a larger distance between the rectifier plate itself and an upward surface of a correspondingly opposed one of the storage disks.

12. The storage disk drive according to claim 11, wherein the rectifier plates are individually positioned in a space between adjacent ones of the storage disks, a distance being set minimum between a specific one of the rectifier plates and a downward surface of the storage disk, said specific one of the rectifier plates being opposed to the storage disk from a downside at a position closest to the base, the rectifier plate at a position remoter from the base in the axial direction of the spindle being positioned to set a larger distance between the rectifier plate itself and a downward surface of a correspondingly opposed one of the storage disks.

13. The storage disk drive according to claim 12, wherein a distance between the rectifier plate and a corresponding one of the storage disks opposed to an upward surface of the rectifier plate is set larger than a distance between the rectifier plate and a corresponding one of the storage disks opposed to a downward surface of the rectifier plate.

14. The storage disk drive according to claim 11, wherein the downward surface of the rectifier plate is positioned closer to the base from a position determined based on an accumulated tolerance resulting from cumulated maximum allowances for the storage disks and the spacer or spacers.

15. An aerodynamic member for a storage disk drive, comprising:
a support piece supported on a base in the storage disk drive, said support piece extending in an axial direction of a spindle; and
rectifier plates extending from the support piece in the storage disk drive in a horizontal direction perpendicular to the axial direction, each of the rectifier plates being located in a space between adjacent ones of storage disks mounted on a spindle hub, wherein
a distance is set minimum between the adjacent ones of the rectifier plates at a position closest to the base, a distance being set maximum between the adjacent ones of the rectifier plates at a position remotest from the base, the rectifier plate at a position remoter from the base in the axial direction of the spindle being positioned to set a larger distance between the rectifier plate itself and an upward surface of a corresponding one of the rectifier plates.

16. An aerodynamic member for a storage disk drive, comprising:
a support piece supported on a base in the storage disk drive, said support piece extending in an axial direction of a spindle; and
rectifier plates extending from the support piece in the storage disk drive in a horizontal direction perpendicular to the axial direction, each of the rectifier plates being located in a space between adjacent ones of storage disks mounted on a spindle hub, wherein
a thickness is set maximum for one of the rectifier plates at a position closest to the base, a thickness being set minimum for one of the rectifier plates at a position remotest from the base, a smaller thickness being set for the rectifier plate at a position remoter from the base in the axial direction of the spindle.
